(19) United States
(12) Patent Application Publication
(10) Pub. No.: US 2017/0220354 A1
(43) Pub. Date: Aug. 3, 2017

(54) SERVER NODE SHUTDOWN

(71) Applicant: HEWLETT PACKARD ENTERPRISE DEVELOPMENT LP, Houston, TX (US)

(72) Inventors: David C. Valdez, Houston, TX (US); Patrick A. Raymond, Houston, TX (US); Justin H. Park, Houston, TX (US); David P. Mohr, Spring, TX (US); Hai Ngoc Nguyen, Spring, TX (US)

(21) Appl. No.: 15/328,191

(22) PCT Filed: Nov. 12, 2014
(86) PCT No.: PCT/US14/65222

§ 371 Date: Jan. 23, 2017

(51) Int. Cl. G06F 9/44; G06F 1/26; G06F 1/30; G06F 1/32; G06F 3/06

(52) U.S. Cl. CPC G06F 9/442; G06F 1/3287; G06F 1/3296; G06F 3/0679; G06F 3/065; G06F 3/0619; G06F 1/305; G06F 1/263

(57) ABSTRACT

Example implementations relate to server node shutdown. For example, a server node shutdown can include detecting a secondary power supply integrated into a server node, receiving a primary power supply interruption signal from the secondary power supply, and initiating a sequenced shutdown of the server node in response to receiving the signal using the secondary power supply.

### BACKGROUND

As reliance on computing systems continues to grow, so too does the demand for reliable power systems and backup schemes for these computing systems. Servers, for example, may provide architectures for backing up data to flash or persistent memory as well as backup power sources for powering this backup of data after an interruption of power. Data may be backed up as part of a sequenced shutdown of a server.

### BRIEF DESCRIPTION OF THE DRAWINGS

FIG. 1 illustrates a block diagram of an example of a system for server node shutdown according to the present disclosure;

FIG. 2 illustrates a diagram of an example of a computing device according to the present disclosure; and

FIG. 3 illustrates an example of a method suitable for server node shutdown according to the present disclosure.

### DETAILED DESCRIPTION

A computing and/or data storage system can include a number of nodes that support a number of loads. The nodes can be a number of servers (e.g., a server node), for example. A number of loads can include storage controllers or devices associated with the server nodes. For example, a load can include cache memory, dual inline memory modules (DIMMs), Non-Volatile Dual In-Line Memory Modules (NVDIMMs), and/or array control logic, among other storage controllers and/or devices associated with the servers.

An interruption of a primary power supply can be scheduled or un-scheduled. For instance, a scheduled interruption of the primary power supply can be the result of scheduled maintenance on the number of server nodes and/or the number of loads. An un-scheduled primary power supply interruption can be an interruption in the primary power supply. An un-scheduled primary power supply interruption can occur when, for example, the primary power supply fails momentarily and/or for an extended period of time. Failure can include an unintentional loss of power to nodes and/or loads from the primary power supply.

A micro-uninterruptible power supply (μUPS) can be an integrated secondary power supply that is used to provide emergency power to a load when a primary power supply (e.g., input power source) is interrupted. Interruption of a primary power supply can refer to a power failure, power surge, inadequate power, and/or transient faults. A μUPS can provide near-instantaneous protection from power interruptions by supplying energy stored in batteries, super capacitors, or flywheels, among others.

It may be desirable to move data from volatile cache memory in the number of nodes to non-volatile memory upon the removal of a primary power supply. However, moving data from cache memory to non-volatile memory can involve a secondary power supply. The secondary power supply can include an integrated secondary power supply. For example, the integrated secondary power supply can include a μUPS that is used to provide power for moving data from cache memory to non-volatile memory when the primary power is interrupted. Further, the μUPS can reside in a power supply slot of the server node and/or be a shared μUPS, in that the shared μUPS associated with a particular server node is shared among a plurality of loads associated with that server node. The μUPS can be integrated into the node. That is, a server node can have a μUPS integrated into the body of the server node. With integration of a μUPS into each of the server nodes, a server rack and/or chassis can include a plurality of μUPSs to supply backup power to its plurality of server nodes.

Examples of the present disclosure can include a system that can detect a secondary power supply integrated into a server node and receive a primary power supply interruption signal from the secondary power supply. The system can initiate a sequenced shutdown of the server node responsive to receiving the signal using the secondary power supply.

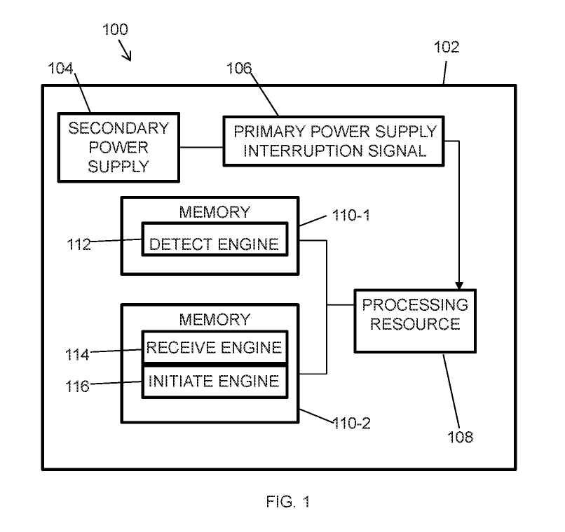

FIG. 1 illustrates a block diagram of an example of a system 100 for server node shutdown according to the present disclosure. As illustrated in FIG. 1, the system 100 can include a server node 102, a secondary power supply 104 (e.g., a μUPS), a primary power supply interruption signal 106, a processing resource 108, memory 110-1 and 110-2, and a number of engines (e.g., detect engine 112, receive engine 114, initiate engine 116).

A secondary power supply 104 refers to power supply that is an integrated component of the server node 102 and is used to provide power for transferring data from volatile cache memory to non-volatile memory when a primary power supply is interrupted. The secondary power supply 104 can include a μUPS. A μUPS, as used herein, refers to an electrical apparatus that provides a temporary supply of power to a load when a primary power supply is interrupted (e.g., fails) and can be integrated into the body of the server node (e.g., an integrated component of the server node). An integrated component of the server node, as used herein, can include a separate component from the server node that is combined with the body of the server node such that the server node and the integrated component function together as a single unit. For example, a μUPS can reside in a power supply slot of the server node (e.g., be physically and/or directly plugged in to a power supply slot of the server node). The secondary power supply 104 can be an integrated component of a server node 102 and/or provide the temporary source of power to a load associated with server node 102 for a threshold of time. The secondary power supply 104 can be used to protect hardware and components of the system 100, such as a processing resource 108 (e.g., system central processing unit (CPU)) and various systems (e.g., dual in-line memory modules, etc.), from data loss in response to the primary power supply interruption.

The server node 102 can host a number of devices, such as local memory or data storage (e.g., referred to generally as memory 110-1 and 110-2). The memory 110-1 and 110-2 may contain volatile and non-volatile memory (e.g., cache, DIMM, NVDIMM). The server node 102 can include other devices such as cache memory, DIMMs, array control logic, and storage controllers, among other devices associated with the server node 102. In some examples, the server node 102 can also include a control logic unit (not shown). The memory 110-1 and 110-2 can be separate memory locations. For example, memory 110-1 can be read only memory (ROM) locations storing a basic input/output system (BIOS) and memory 110-2 can be a separate memory location storing operating system (OS) drivers. In such examples, the detect engine 112 can be the BIOS and the receive engine 114 and/or initiate engine 116 can be OS drivers.

The memory 110-1 and 110-2 can be in communication with the processing resource 108 via a communication link and can include the number of engines (e.g., detect engine 112, receive engine 114, initiate engine 116). Although FIG. 1 illustrates a single processing resource 108, memory 110-1 can be in communication with a first processor and memory 110-2 can be in communication with a second processor. The memory 110-1 and 110-2 can include additional or fewer engines than are illustrated to perform the various functions as will be described in further detail. A portion of the number of engines (e.g., receive engine 114, initiate engine 116) can be driver level code (e.g., instructions executable by a processing resource (e.g., processing resource 108) of the server node 102 to cause a computing device to perform a function) that is specific to an operating system of the server node 102. A portion of the number of engines (e.g., detect engine 112) can be BIOS level code (e.g., instructions executable by a processing resource (e.g., processing resource 108) of the server node 102 to cause a computing device to perform a function).

The detect engine 112 can detect a secondary power supply 104 integrated into the server node 102. That is, the secondary power supply can include an integrated power supply used to provide power for transferring data from volatile cache memory to non-volatile memory when a primary power supply is interrupted. By contrast, a primary power supply can include an alternating current (AC) power supply such as voltage from a wall outlet (mains supply) and lowers it to a desired voltage. Detecting a secondary power supply 104 can include detecting the presence of a secondary power supply 104 integrated into the server node 102. For example, detecting a secondary power supply 104 can include detecting the supply of power from the secondary power supply 104.

In a number of examples, detecting a secondary power supply 104 can include detecting a power level and/or power status (fully charged, charging, etc.) of the secondary power supply 104. Detecting a power level can include detecting an amount of power of the secondary power supply 104 (e.g., a percent charge of full capacity of the secondary power supply 104, a measurement of units of energy held by the secondary power supply 104, etc.).

Detecting a secondary power supply 104 can be accomplished by the basic input/output system (BIOS) (not illustrated by FIG. 1 for clarity purposes) of the server node 102 communicating with the secondary power supply 104 via inter-integrated circuit (I²C) and/or another communication mechanism detecting the presence of a secondary power supply 104 versus a standard power supply. The BIOS can also read a power level of the secondary power supply 104. The BIOS can communicate to storage firmware via a unified extensible firmware interface (UEFI) protocols to communicate with a memory controller that a secondary power supply 104 is present and/or that a volatile cache backup can occur in the future. The BIOS can also communicate a power level of the secondary power supply 104. The BIOS can publish the secondary power supply 104 presence and/or power level data to an operating system (OS) of the server node 102 via industry standard protocols (e.g., UEFI, advanced configuration and power interface (ACPI), system management BIOS (SMBIOS)). Additionally, BIOS can provide instructions to the OS via ACPI methods regarding how to poll secondary power supply 104 power levels and/or power status. In an example, a non-volatile dual in-line memory module (NVDIMM) driver and/or a memory storage controller driver can detect the presence of a secondary power supply 104 via a BIOS-to-OS communication layer.

Detecting a secondary power supply 104 can include determining whether the power level of the secondary power supply 104 is adequate to power the server node 102 through a write of data from a volatile memory location of the server node 102 to a non-volatile memory location of the server node 102. For example, detecting a secondary power supply 104 can include comparing a determined power level of the secondary power supply 104 to a threshold power level. The threshold power level can include an amount of power involved in performing a sequenced shutdown of the server node 102 including writing data from a volatile memory location of the server node 102 to a non-volatile memory location of the server node 102.

In some examples, the system 100 can include an enable engine (not illustrated by FIG. 1). When a power level of a secondary power supply 104 reaches or exceeds the threshold then the enable engine can enable a cache backup up option (e.g., write-back caching, etc.) via a storage controller and can enable non-volatile memory (persistent memory) via a NVDIMM driver for use in the cache backup option.

The receive engine 114 can receive a primary power supply interruption signal 106 from the secondary power supply 104. In the event of an interruption of a primary power supply, the secondary power supply 104 can detect the loss of power from the primary power supply and begin to supply power to the loads of the server node 102. The secondary power supply 104, in response to the interruption of a primary power supply, can generate a primary power supply interruption signal 106. A primary power supply interruption signal 106 can be a signal that communicates an instruction and/or a command such as an instruction and/or command to initiate a sequenced shutdown of the server node 102 including writing data from a volatile memory location of the server node 102 to a non-volatile memory location of the server node 102. In an example, a primary power supply interruption signal 106 can include a signal from a power supply unit of the secondary power supply 104 communicated through a system complex programmable logic device (CPLD) wired into a power button logic of the server node 102 to initiate a sequenced shutdown of the server node 102 as if a power button on the server node 102 had been pressed.

In an additional example, a primary power supply interruption signal 106 can be a signal from a power supply unit of the secondary power supply 104 propagated using a general purpose input (GPI) pin on a southbridge (e.g., a chipset to handle input/output (IO) functions) or CPU. In such an additional example, the pin can be programmed to signal a primary power supply interruption to the OS and the server node 102 can then execute an initiate engine 116. In such examples, the processing resource 108 illustrated by FIG. 1 is the CPU of the server node 102.

The initiate engine 116 can initiate a sequenced shutdown of the server node 102 responsive to receiving the primary power supply interruption signal 106 using the secondary power supply 104. A sequenced shutdown of the server node 102 can include executing a sequence of instructions in powering down the server node 102 while retaining the server node's 102 state (e.g., retaining all or a portion of the stored data in server node 102 despite removing power from, for example, the volatile memory of the server node 102). In an example, a primary power supply interruption signal 106 can initiate a sequenced shutdown from the OS of the server node 102. The primary power supply interruption signal 106 can call into a NVDIMM driver and a control storage driver of the server node 102. These drivers can determine the power levels and status of the secondary power supply 104.

The determined power levels of the secondary power supply 104 can be compared to threshold power levels. A determined power level of the secondary power supply 104 refers to an amount of power available from (or on) the secondary power supply 104. A threshold power level of the secondary power supply 104 can be a predetermined amount of power that can adequately power the loads of the server node 102 through a backup write of the data contents of the volatile memory of the server node 102 to non-volatile memory (e.g., flash memory, a solid state drive (SSD), hard disk drive (HDD), etc.) of the server node 102. If the determined power levels of the secondary power supply 104 meet and/or exceed the threshold power levels then the backup write of the data can be initiated and/or performed by the server node 102. That is, the server node 102 can perform the sequenced shutdown including writing data from a volatile memory location of the server node 102 to a non-volatile location of the server node 102 in response to a determination that the power level of the secondary power supply 104 is adequate to power the server node 102 through the write.

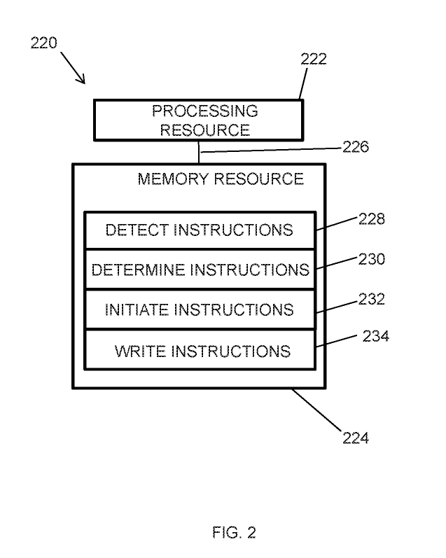

FIG. 2 illustrates a diagram of a computing device 220 according to the present disclosure. The computing device 220 can utilize software, hardware, firmware, and/or logic to perform functions described herein. The computing device 220 can include a server node, such as the server node 102 illustrated in FIG. 1. The computing device 220 can be any combination of hardware and program instructions to share information. The hardware, for example, can include a processing resource 222 and/or a memory resource 224 (e.g., non-transitory computer-readable medium (CRM), machine readable medium (MRM), database, etc.). A processing resource 222, as used herein, can include any number of processors capable of executing instructions stored by a memory resource 224. Processing resource 222 can be implemented in a single device or distributed across multiple devices. The program instructions (e.g., computer readable instructions (CRI)) can include instructions stored on the memory resource 224 and executable by the processing resource 222 to implement a desired function (e.g., detect a secondary power supply integrated into a server node; determine a power level of the secondary power supply; initiate a sequenced shutdown of the server node in response to receiving a primary power supply interruption signal from the secondary power supply; write data from a volatile memory location of the server node to a non-volatile memory location of the server node in response to determining the power level of the backup power supply is above a threshold power level; etc.).

The memory resource 224 can be in communication with the processing resource 222 via a communication link (e.g., a path) 226. The communication link 226 can be local or remote to a machine (e.g., a computing device) associated with the processing resource 222. Examples of a local communication link 226 can include an electronic bus internal to a machine (e.g., a computing device) where the memory resource 224 is one of volatile, non-volatile, fixed, and/or removable storage medium in communication with the processing resource 222 via the electronic bus.

A number of instructions (e.g., detect instructions 228; determine instructions 230; initiate instructions 232; write instructions 234) can include CRI that when executed by the processing resource 222 can perform functions. The number of instructions can be sub-instructions of other instructions. For example, the determine instructions 230 and the initiate instructions 232 can be sub-instructions and/or contained within the same computing device. In another example, the number of instructions can comprise individual instructions at separate and distinct locations (e.g., CRM, etc.).

Each of the number of instructions can include instructions that when executed by the processing resource 222 can function as a corresponding engine as described herein. For example, the detect instructions 228 and the determine instructions 230 can include instructions that when executed by the processing resource 222 can function as the detect engine 112. In another example, the initiate instructions 232 can include instructions that when executed by the processing resource 222 can function as the receive engine 114. In another example, the write instructions 234 can include instructions that when executed by the processing resource 222 can function as the initiate engine 116.

Detect instructions 228 can be executed by the processing resource 222 to cause the computing device 220 to detect a secondary power supply integrated into a server. Detecting the secondary power supply can include detecting the presence of a secondary power supply and/or that the loads of a server node are being powered by a secondary power supply as opposed to a primary power supply. Detecting the secondary power supply can include instructions executable by the processing resource 222 to notify a storage controller of the server node, in response to detecting a presence of the secondary power supply, that a cache backup may be requested.

Determine instructions 230 can be executed by the processing resource 222 to cause the computing device 220 to determine a power level of the secondary power supply. Determining the power level of the secondary power supply can include instructions executable by the processing resource 222 to periodically poll an amount of power of the secondary power supply. Alternatively, determining the power level of the secondary power supply can include instructions executable by the processing resource 222 to receive an amount of power of the secondary power supply published by a BIOS of the server node.

In some examples, the primary power supply interruption signal can include a computer-readable instruction from the secondary power supply 104. In such examples, receive instructions (not illustrated by FIG. 1) can be executed by the processing resource 222 to cause the computing device 220 to receive a primary power supply interruption signal from the secondary power supply.

Initiate instructions 232 can be executed by the processing resource 222 to cause the computing device 220 to initiate a sequenced shutdown of the server node in response to a primary power supply interruption signal form the secondary power supply. In an example, a sequenced shutdown of the server node can be initiated in response to a primary power supply interruption signal received through a system CPLD of the server node. Initiating a sequenced shutdown can include initiating execution of instructions by the processing resource 222 resulting in an ordered power down of the server node.

The power down can include transitioning the server node to a low-power sleep mode in which the processing functions of the server node are powered down using a relatively small amount of power from the secondary power supply to preserve the contents of its volatile memory (e.g., a sleep mode). Alternatively, the power down can include write instructions described below (e.g., a hibernation mode). As described below, the type of power down (e.g., sleep mode power down versus a hibernation mode power down) can be selected based on the power level of the secondary power supply (e.g., in relation to an amount of power to perform a write of data from a volatile memory location of the server node to a non-volatile memory location of the server node.

Write instructions 234 can be executed by the processing resource 222 to cause the computing device 220 to write data from a volatile memory location of the server node to a non-volatile memory location of the server node. The write can be performed in response to determining the power level of the secondary power supply is above a threshold power level. The threshold power level can be a predetermined power level adequate to power the loads of the server node throughout the sequenced shutdown and/or write.

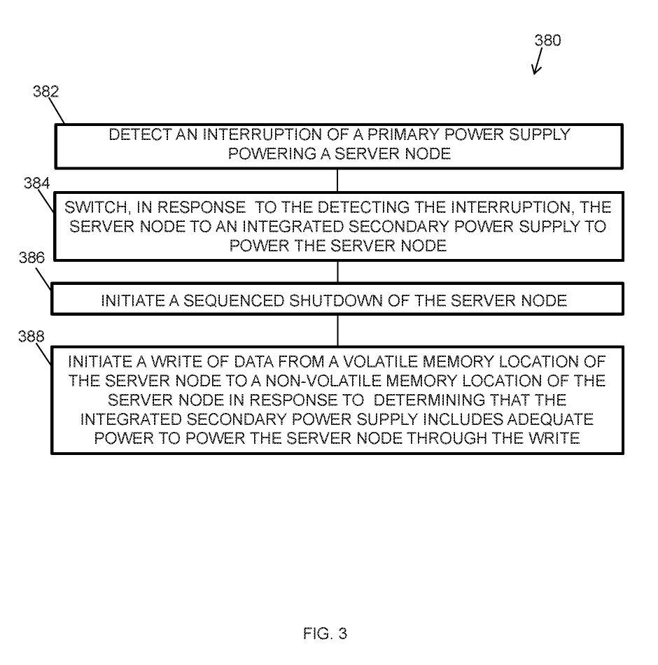

FIG. 3 illustrates a flow chart of an example method 380 for server node shutdown according to the present disclosure. In some examples, the method 380 can be performed utilizing a system (e.g., system 100 as referenced in FIG. 1) and/or a computing device (e.g., computing device 220 as referenced in FIG. 2).

At 382, the method 380 can include detecting an interruption of a primary power supply powering a server node. Detection of an interruption of a primary power supply can be performed by and communicated from a secondary power supply. That is, the server node can use the secondary power supply to detect interruption of the primary power supply (e.g., by receiving a signal from the secondary power supply once the primary power supply is interrupted, detecting the provision of power from a secondary power supply as opposed to a primary power supply, etc.)

At 384, the method 380 can include switching, in response to detecting the primary power source interruption, the server node to an integrated secondary power supply. The integrated secondary power supply can be a μUPS integrated into the server node.

At 386, the method 380 can include initiating a sequenced shutdown of the server node. For example, the method 380 can include generating a signal initiating a sequenced shutdown from the OS of the server node in response to detection of the detection of the interruption of the primary power supply.

At 388, the method 380 can include initiating a write of data from a volatile memory location of the server node to a non-volatile memory location of the server in response to determining the integrated secondary power supply includes adequate power to power the server node through the write. An adequate power to power the server node refers to a power level of the integrated secondary power supply being meeting or exceeding a threshold power level. The server node can monitor power levels of the secondary power supply and once the power levels of the server node meet or exceed a threshold power level the server node can enable a write-back cache and a NVDIMM.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present disclosure, and should not be taken in a limiting sense.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A server node shutdown system, comprising:
a detect engine to detect a secondary power supply integrated into a server node;
a receive engine to receive a primary power supply interruption signal from the secondary power supply; and
an initiate engine to initiate a sequenced shutdown of the server node in response to receiving the signal using the secondary power supply.

2. The system of claim 1, wherein the secondary power supply is an uninterruptable power source (UPS).

3. The system of claim 1, wherein the detect engine detects the secondary power supply including a power level of the secondary power supply.

4. The system of claim 3, wherein the detect engine further determines whether the power level of the secondary power supply is adequate to power the server node through a write of data from a volatile memory location of the server node to a non-volatile memory location of the server node.

5. The system of claim 4, wherein the server node performs the sequenced shutdown including writing the data from the volatile memory location of the server node to the non-volatile memory location of the server node in response to a determination that the power level of the secondary power supply is adequate to power the server node through the write.

6. The system of claim 4, wherein the server node performs the sequenced shutdown including transitioning to a low-power sleep mode in response to a determination that the power level of the secondary power supply is inadequate to power the server node through the write.

7. The system of claim 1, further comprising an enable engine to enable a cache backup option in response to detecting the secondary power supply.

8. A non-transitory machine readable medium storing instructions executable by a processing resource to cause a computing device to:
detect a secondary power supply integrated into a server node;
determine a power level of the secondary power supply;
initiate a sequenced shutdown of the server node in response to receiving a primary power supply interruption signal from the secondary power supply; and
write data from a volatile memory location of the server node to a non-volatile memory location of the server node in response to determining the power level of the secondary power supply is above a threshold power level.

9. The medium of claim 8, wherein detecting the secondary power supply comprises instructions executable by the processing resource to notify a storage controller of the server node, in response to detecting a presence of the secondary power supply, that a cache backup may be requested.

10. The medium of claim 8, wherein determining the power level of the secondary power supply comprises instructions executable by the processing resource to periodically poll an amount of power of the secondary power supply.

11. The medium of claim 8, wherein determining the power level of the secondary power supply comprises instructions executable by the processing resource to receive an amount of power of the secondary power supply published by a basic input/output system (BIOS) of the server node.

12. A method of server node shutdown, comprising:
detecting an interruption of a primary power supply powering a server node;
switching, in response to the detecting the interruption, the server node to an integrated secondary power supply to power the server node;
initiating a sequenced shutdown of the server node; and
initiating a write of data from a volatile memory location of the server node to a non-volatile memory location of the server node in response to determining the integrated secondary power supply includes adequate power to power the server node through the write.

13. The method of claim 12, wherein initiating the write comprises enabling a write-back cache and a non-volatile dual in-line memory module (NVDIMM).

14. The method of claim 12, wherein detecting the interruption of the primary power supply comprises detecting the interruption using the integrated secondary power supply.

15. The method of claim 14, generating a signal initiating a sequenced shutdown from an operating system of the server node using the integrated secondary power supply in response to the detection of the interruption of the primary power supply.
